(19) United States
(12) Patent Application Publication
(10) Pub. No.: US 2003/0072499 A1
(43) Pub. Date: Apr. 17, 2003

(54) Paper detecting apparatus utilizing linear sensor

(75) Inventors: Hideki Sawada, Kyoto (JP); Motoshi Uehara, Kyoto (JP); Hiroshi Fukumoto, Kyoto (JP)

Correspondence Address: MERCHANT & GOULD PC, P.O. BOX 2903, MINNEAPOLIS, MN, 55402-0903, US

(73) Assignee: ROHM CO., LTD., KYOTO-SHI (JP)

(21) Appl. No.: 10/232,944

(22) Filed: Aug. 30, 2002

(30) Foreign Application Priority Data
Aug. 31, 2001 (JP) 2001-263046

(51) Int. Cl. G06T 7/60; G06K 9/36

(52) U.S. Cl. 382/289

(57) ABSTRACT

A paper detecting apparatus includes a transfer base, a first and a second linear sensors, and a data processor. The transfer base transfers a paper in a predetermined transfer direction, and the paper includes a first and a second side edges in parallel to each other. The first linear sensor includes a first linear reading region for detecting the first side edge of the paper. The second linear sensor includes a second linear reading region for detecting the second side edge of the paper. The data processor processes the data obtained by the first and the second sensors. The first and the second sensors are arranged in a manner such that the first and the second linear reading regions are positioned transversely to the transfer direction. The data processor detects the tilt angle between the paper and the transfer direction based on the positional information of the first and the second side edges obtained by the first and the second sensors.

### BACKGROUD OF THE INVENTION

1. Field of the Invention

The present invention relates to a paper detecting apparatus comprising a plurality of linear sensors. In particular, the present invention relates to an apparatus for detecting an angle defined between a rectangular sheet of paper and a predetermined path along which the paper is transferred.

2. Description of the Related Art

Image processing apparatuses such as printers or scanners include those which performs printing or reading while transferring a print paper sheet or a document paper sheet. Scanners comprise a transfer base for advancing a document paper in a predetermined transfer direction (a secondary scanning direction), and an image reading unit disposed adjacent to the transfer base. The image reading unit includes a sensor with a reading region elongated perpendicularly to the transfer direction, that is, in a primary scanning direction. Images (including words and symbols) read from a document are stored in a memory as data formatted in a rectangle (i.e. image data formed by arranging data in a plurality of rows extending in the primary scanning direction and spaced from each other in the secondary scanning direction).

The rectangular format is determined based on the premise that the side edges of the document paper sheet and the transfer direction are parallel to each other. Thus, once a document paper on a scanner tilts relative to the transfer direction in the reading process, it is conventionally impossible to record proper image data based on the format. Conventional printers also fail to print images properly on a print paper if the print paper tilts relative to the transfer direction.

### SUMMARY OF THE INVENTION

The present invention, which has been conceived under the circumstances described above, has as its object to provide an apparatus for detecting the tilting condition of a paper sheet (e.g. a document or a print paper) transferred along a predetermined path. By performing corrections to image data (image data to be read or image data to be printed) in response to the tilt detection of the paper, it is possible to appropriately store or print the data.

The present invention provides a paper detecting apparatus which comprises: a transfer base for transferring a sheet of paper in a predetermined transfer direction, the paper including a first and a second side edges in parallel to each other; a first linear sensor including a first linear reading region for detecting the first side edge; a second linear sensor including a second linear reading region for detecting the second side edge; and a data processor for processing data obtained by the first and the second sensors. The first and the second sensors are disposed in such a manner that the first and the second linear reading regions are positioned transversely to the transfer direction. The data processor detects a tilt angle of the paper relative to the transfer direction based on positional information of the first and the second side edges obtained by the first and the second sensors.

Preferably, the data processor detects the tilt angle based on first and second positional information. The first positional information is obtained when the paper assumes a first position, whereas the second positional information is obtained when the paper assumes a second position different from the first position.

Preferably, the first and the second sensors are located offset from each other in the transfer direction.

Preferably, each of the first and the second sensors includes an illuminator for irradiating the paper with scattered light rays.

Preferably, the illuminator includes light-emitting elements of red, green, and blue colors.

Preferably, the transfer base includes a black surface for placing the paper.

Preferably, the detecting apparatus according to the present invention further comprises a third linear sensor including a third linear reading region for detecting an edge of the paper extending between the first and the second side edges. The third linear reading region extends in parallel to the transfer direction.

Other features and advantages of the present invention will become apparent form the following detailed description.

### BRIEF DESCRIPTION OF THE DRAWINGS

FIG. 1 is a perspective view showing a principle portion of a paper detecting apparatus in accordance with a first embodiment of the present invention.

FIG. 2 is a sectional view taken along II-II in FIG. 1.

FIG. 3 is a sectional view taken along III-III in FIG. 1.

FIG. 4 is a plan view showing light-emitting elements utilized as light sources for the paper detecting apparatus.

FIGS. 5A-5B and FIG. 6 are views illustrating the functions of the paper detecting apparatus.

FIG. 7 is a perspective view showing a principle portion of a paper detecting apparatus in accordance with a second embodiment of the present invention.

FIGS. 8 and 9 are views illustrating the functions of the apparatus shown in FIG. 7.

FIG. 10 is a perspective view showing a principle portion of a paper detecting apparatus in accordance with a third embodiment of the present invention.

FIG. 11 is a plan view showing a positional relationship among the three linear sensors shown in FIG. 10 and a sheet of paper.

### DETAILED DESCRIPTION OF PREFERRED EMBODIMENTS

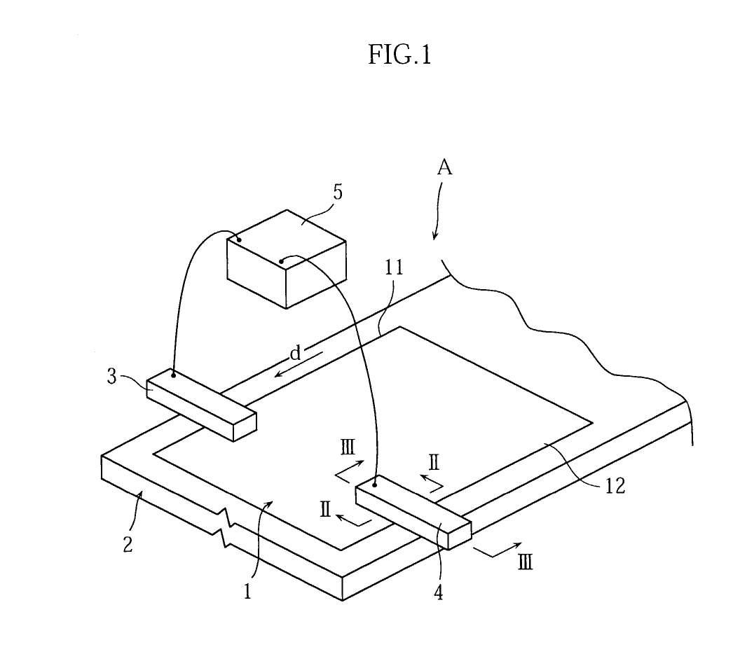

FIGS. 1-3 illustrate a paper detecting apparatus in accordance with a first embodiment of the present invention. The detecting apparatus (generally represented by a reference sign A) may be incorporated into a printer to detect the orientation of a print paper 1 transferred along a predetermined transfer path. The paper 1 is rectangular and has a standardized size (e.g. A4 or B5) with a first and a second side edges 11, 12 which are parallel to each other. The detecting apparatus A may be alternatively incorporated into a scanner to detect the orientation of a document paper which is transferred in course of image reading.

As shown in FIG. 1, the detecting apparatus A comprises a transfer base 2, a first linear sensor 3, a second linear sensor 4 and an image data processor 5.

The transfer base 2 may be made of a resin for example, and includes a plurality of rollers (not shown) for advancing the paper 1 in a transfer direction d (see FIG. 1). The transfer base 2 includes an upper surface in black color so that the light reflection thereon is restricted. Thus, the sensors 3, 4 detect the first and the second side edges 11, 12 precisely.

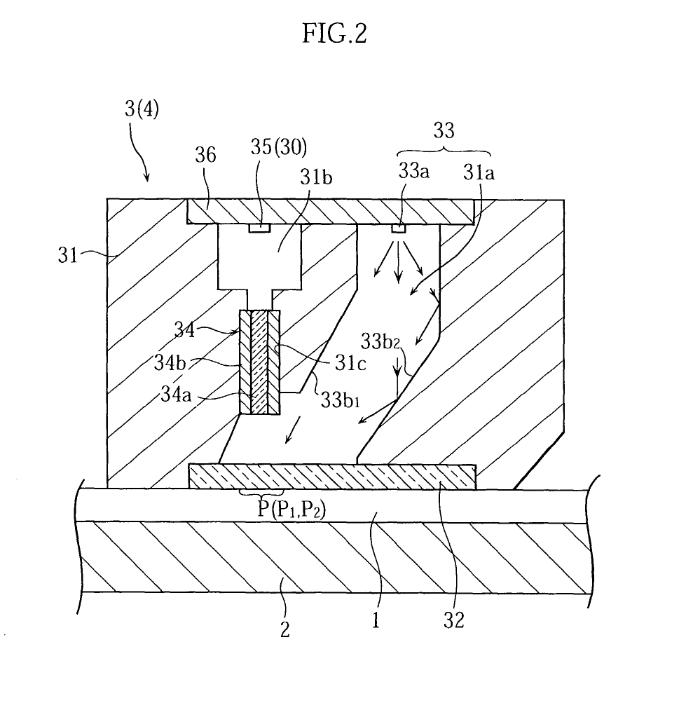

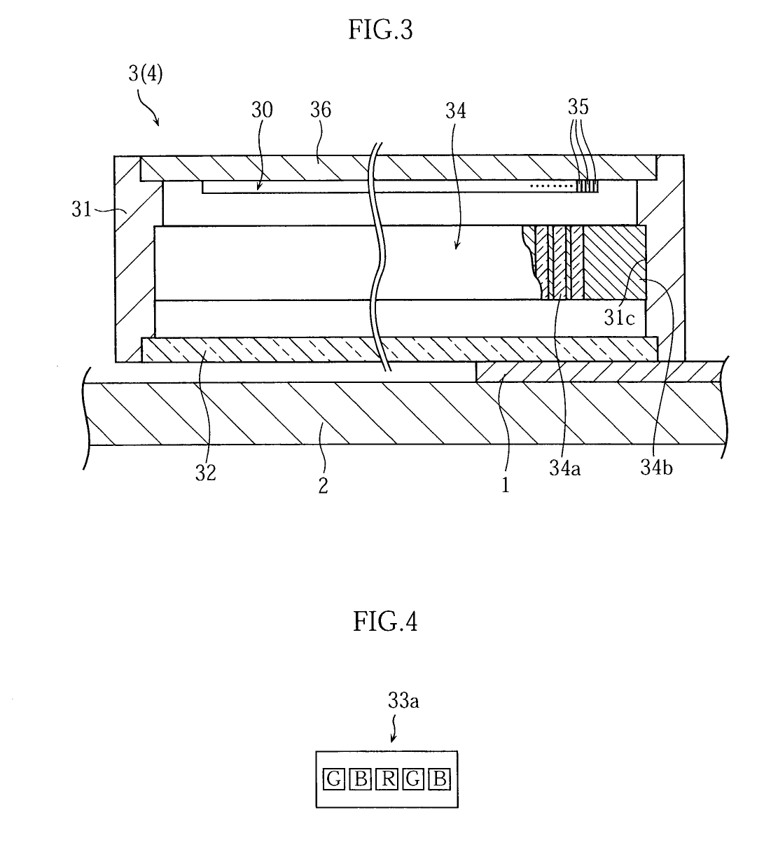

As shown in FIGS. 2 and 3, each of the sensors 3, 4 comprises a case 31, a cover 32, an illuminator 33, a lens array 34, a plurality of photoelectric converters 35 and a circuit board 36.

The case 31, which may be made of a synthetic resin for example, is relatively elongate perpendicularly to the paper transfer direction d (see FIG. 1). As shown in FIG. 2, the case 31 is formed with a light passage 31a penetrating thicknesswise of the case (vertically in that figure). The light passage 31a also extends longitudinally of the case 31. The case 31 includes a space 31b at an upper portion to house the photoelectric converters 35. Like the light passage 31a, the space 31b extends longitudinally of the case 31.

The cover 32 may be made, for example, of a transparent glass or a transparent synthetic resin such as an acrylic resin. As shown in FIG. 2, the cover 32 is attached to the case 31 from below to close the light passage 31a. The cover 32 includes a lower surface facing the paper 1. The lower surface provides a reading line P extending immediately below the lens array 34 longitudinally of the case 31.

As shown in FIG. 2, the illuminator 33 includes a plurality of light sources 33a along with the light passage 31a mentioned above. The board 36 has a lower surface on which the light sources 33a are mounted as spaced from each other longitudinally of the case 31 at a suitable interval. As shown in FIG. 4, each of the light sources 33a comprises light-emitting diodes of red color (R), green color (G), and blue color (B). By utilizing the thus colored light emitting elements, suitably colored light may be irradiated onto the paper 1 depending on the color of the paper 1. In this way, the first and the second side edges 11, 12 of the paper 1 can be precisely detected based on the image data which is obtained by the first and the second sensors 3, 4. The light passage 31a leads the light rays emitted from the light sources 33a to the reading line P. Specifically, as shown in FIG. 2, the light passage 31a includes light reflective faces 33b₁, 33b₂. In travelling from the light sources 33a to the reading line P, the light rays are repetitively reflected on these reflective faces. The light reflective faces 33b₁, 33b₂ are colored in white to improve the light reflectivity while scattering the light rays coming from the light sources. Thus, the paper is uniformly irradiated over the entire reading line P.

The lens array 34 collects the light rays reflected on the paper 1 and the transfer base 2 onto the photoelectric converters 35. As shown in FIGS. 2 and 3, the lens array 34 includes a plurality of selfoc lenses 34a, and a resin holder 34b for holding these lenses. The lens array 34 is fitted in a fixing groove 31c formed in the case 31. Each of the selfoc lenses 34a includes an optic axis extending perpendicularly to the light receiving face of the respective photoelectric converters 35.

Each of the photoelectric converters 35 outputs an image signal, the level of which is determined by the received amount of light. As shown in FIG. 3, the circuit board 36 includes a lower surface provided with an IC chip 30, in which the photoelectric converters 35 are arranged in a row. The number of the photoelectric converters 35 in a unit length determines the reading resolution of the sensors 3, 4. In the illustrated embodiment, the sensors have the resolution of 8 dots/mm (i.e. 8 photoelectric converters per mm). Thus, a detection is performed with a tolerance of 125 μm at the side edges 11, 12 of the paper 1.

The circuit board 36 may be made of an epoxy resin or a ceramic material for example. As shown in FIG. 2, the circuit board is secured to the upper portion of the case 31.

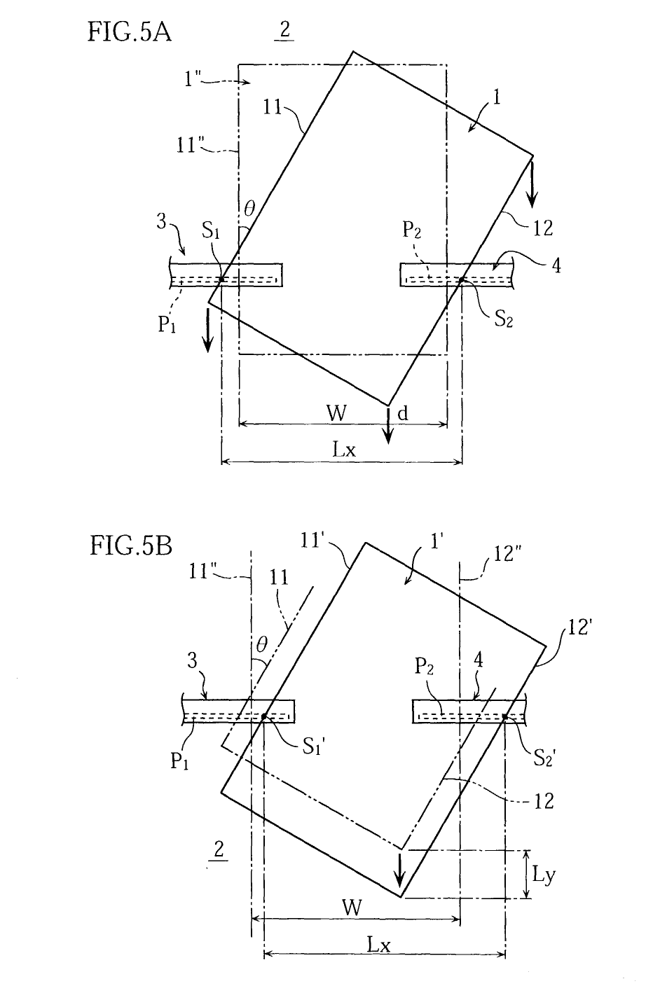

As shown in FIG. 5A, the first and the second sensors 3, 4 are spaced from each other perpendicularly to the transfer direction d. The first sensor 3 and the second sensor 4 provide, respectively, reading lines P₁ and P₂ both of which extend along a common straight line (not shown) perpendicular to the transfer direction d. The first sensor 3 is disposed in a manner such that the reading line P₁ thereof is positioned immediately above the first side edge 11 of the paper 1 at least for a predetermined time required to detect the paper orientation. Similarly, the second sensor 4 also has a reading line P₂ positioned immediately above the second side edge 12 of the paper 1 at least for the same predetermined period of time.

A description is given below as to how the first sensor 3 detects the first side edge 11. Upon turning on the light sources 33a to irradiate the paper 1 and the transfer base 2, reflected light rays enter the photoelectric converters 35. As mentioned above, the upper surface (reflective face) of the transfer base 2 is black so that the reflectivity thereof is lower than that of the paper 1. Therefore, the amount of light impinging on the photoelectric converters above the paper 1 differs from the amount of light impinging on the photoelectric converters facing the transfer base 2. This difference provides a detection for determining the position (S₁ in FIG. 5A) of the first side edge 11 of the paper 1 on the reading line P₁.

The second sensor 4 detects the side edge 12 of the paper 1 in the same way as does the first sensor 3. The second sensor 4 detects the position (S₂ in FIG. 5A) of the second side edge 12 of the paper 1 on the reading line P₂.

The paper 1 advances with time in the transfer direction d. The paper 1 translates in the transfer direction d from the original position (FIG. 5A) by a certain distance (Ly) (FIG. 5B). In FIG. 5B, the paper after transfer is represented by reference sign 1′, whereas the first and the second edges of the transferred paper are designated by reference signs 11′ and 12′, respectively. In this position, another detection is performed to determine the position (S₁′) of the first side edge 11′ on the reading line P₁ as well as the position (S₂′) of the second side edge 12′ on the reading line P₂. In FIGS. 5A and 5B, if the paper 1 tilts relative to the transfer direction d (the tilt angle θ‡0°), the position S₁′ differs from the position S₁ while the position S₂′ differs from the position S₂. When the tilt angle θ is 0°, the position S₁′ coincides with the position S₁ while the S₂′ corresponds to the position S₂. In the figures, the paper with a tilt angle θ of 0° is represented by reference sign 1″.

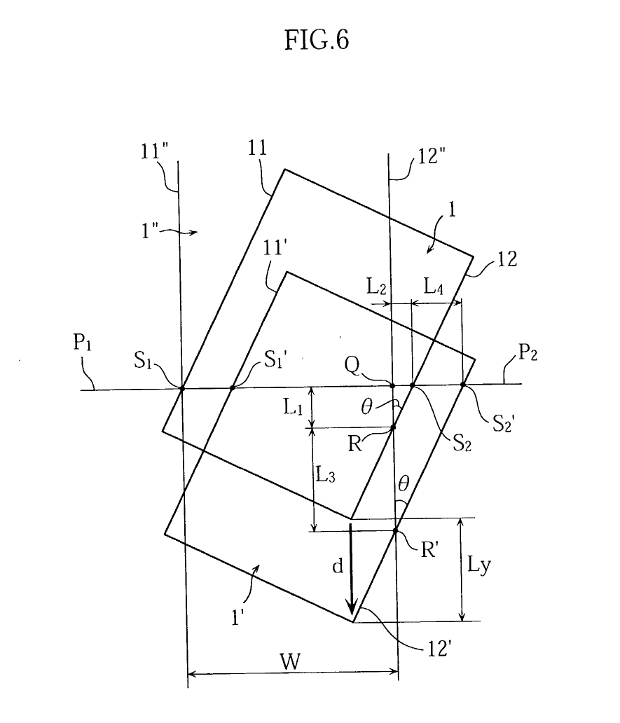

The tilt angle θ may be calculated in the following manner based on the above-noted positions (S₁, S₂, S₁′, S₂′), the paper transfer distance (Ly) and the width (W) of the paper 1. In the description below, reference will be made to FIG. 6 as well as FIGS. 5A and 5B. FIG. 6 is a diagram obtained by overlapping FIGS. 5A and 5B. For simplicity, FIG. 6 shows the position S₁ on the first side edge 11″ of the paper 1″ (θ=0°).

Referring to FIG. 6, the second side edge 12″ of the paper 1″ intersects the reading line P₂ of the second sensor 4 at a point Q. The second side edge 12″ intersects the second side edge 12 of the paper 1 at a point R. Given that the QR length is L₁ and the QS₂ length is L₂, the equation (1) below is derived.

L₂/L₁=tanθ (1)

Further, in FIG. 6, R′ represents the intersection between the second side edge 12″ of the paper 1″ and the second side edge 12′ of the paper 1′. Given that the RR′ length is L₃ and the S₂S₂′ length is L₄, the following equation (2) is derived because the triangle QRS₂ and the triangle QR′S₂′ are similar.

L₁×(L₂+L₄)=L₂×(L₁+L₃) (2)

Given that the S₁S₂ length is Lx, the length L₂ equals Lx−W. The length L₂ is obtainable when the positions S₁ and S₂ are known. The length L₃ is equal to the paper transfer distance Ly. Thus, the length L₄ is obtainable when the positions S₂ and S₂′ are known. As a result, the angle θ is obtainable from these data together with the equations (1) and (2).

The image data processor 5 processes image data obtained by the first and the second sensors 3, 4. Though not shown, the processor comprises provided a CPU (Central Processing Unit), a RAM (Random Access Memory) and the like. The processor 5 calculates the paper tilt angle θ based on the information regarding the positions of the side edges of the paper 1 (FIG. 5A) and of the paper 1′ (FIG. 5B). Specifically, the processor 5 includes the functions of (a) recognizing the positions of the respective photoelectric converters 35, (b) detecting the above-noted positions S₁, S₂, S₁′, S₂′, and (c) calculating the tilt angle θ using the equations (1) and (2). Suppose the processor 5 is loaded in advance with data as to the width W and the transfer distance Ly of the paper 1. For example, the processor 5 may obtain paper data to recognize the width W of the paper 1 by loading the paper data with a driver software used for driving the detecting apparatus A. The processor 5 may recognize the paper transfer distance Ly by determining the rotational number of rollers provided on the transfer base 2 for advancing the paper 1.

By utilizing the detecting apparatus A of the structure described above, the sensors 3, 4 together with the processor 5 function to detect the tilt angle θ of the paper 1. Based on such detection, corrections may be made to the data of images to be printed on the paper 1, thereby realizing an appropriate printing operation even on a paper set out of proper position and orientation.

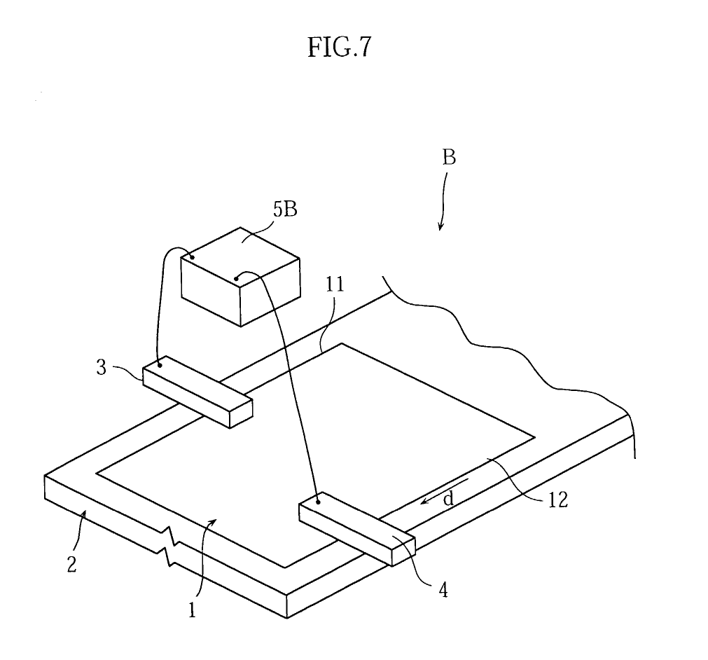

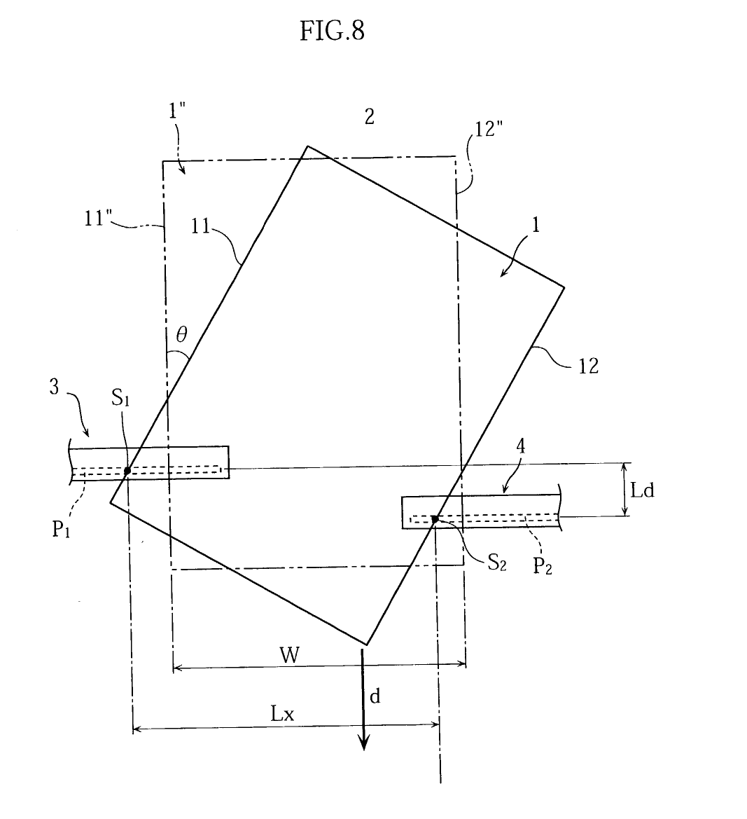

FIGS. 7-9 illustrate a paper detecting apparatus (generally represented by reference sign B) in accordance with a second embodiment of the present invention. The detecting apparatus B is similar in basic structure to the apparatus A of the first embodiment but differs therefrom with respect to the positional relationship between the first sensor 3 and the second sensor 4. Specifically, as shown in FIG. 8, the first and the second sensors 3, 4 are disposed offset from each other in the transfer direction d by a predetermined distance Ld.

The tilt angle θ of a print paper set in the detecting apparatus B is calculated in the following manner.

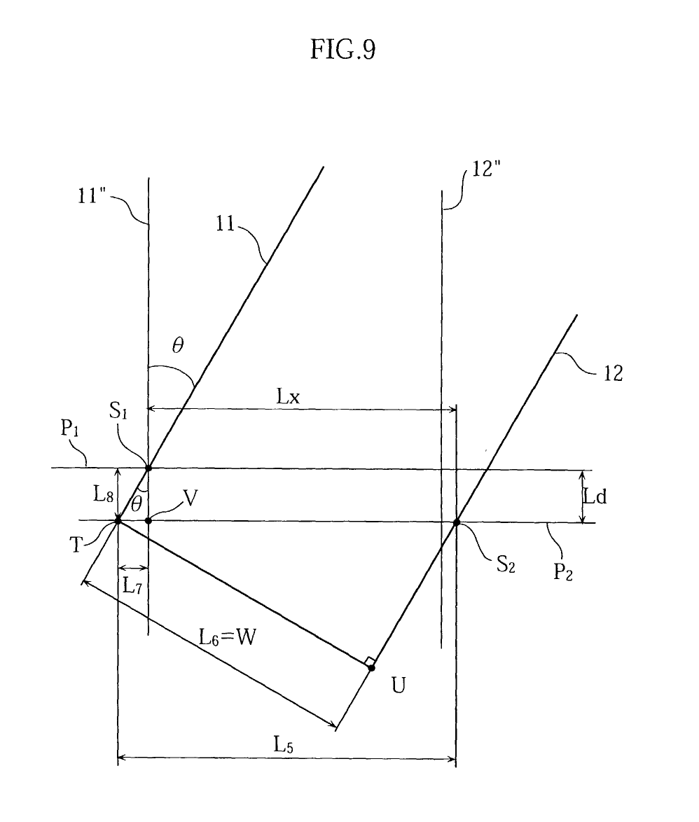

Referring to FIGS. 8 and 9, the reference numeral 1 indicates a paper placed on the transfer base 2 in a tilting state, whereas the reference sign 1″ represents a paper placed in a non-tilting condition (i.e. θ=0° ). FIG. 9 is an illustrative version of FIG. 8, wherein for simplicity the position S₁ (i.e. the intersection between the first side edge of the paper and the reading line of the first sensor) is shown to be located on the first side edge 11″ of the paper 1″.

In FIG. 9, the first side edge 11 (or an extension thereof) intersects an extension of the reading line P₂ of the second sensor 4 at a point T. A perpendicular line drawn from the point T meets the second side edge 12 (or an extension thereof) of the paper 1 at a point U. Given that the TS₂ length is L₅ and the TU length is L₆, the following equation (3) is derived.

L₆L₅×cosθ (3)

The first side edge 11″ of the paper 1″ (or an extension thereof) intersects an extension of the reading line P₂ at a point V. Given that the TV length is L₇ and the VS₁ length is L₈, the following equation (4) is derived.

L₇/L₈=tanθ (4)

The length L₆ herein equals the width W of the paper 1, whereas the length L₈ herein is equal to the distance Ld. Given that the distance between the points S₁ and S₂ longitudinally of the reading line P is Lx, the length L₇ equals L₅−Lx. The length Lx is calculated on the basis of the positions S₁ and S₂. Thus, the tilt angle θ is obtained by the equations (3) and (4).

The detecting apparatus B comprises a processor 5B. The processor 5B provides the functions of (a) recognizing the positions of the respective photoelectric converters 35, (b) detecting the positions S₁, S₂, and (c) calculating the tilt angle θ using the equations (3) and (4). The processor 5B of the detecting apparatus B is loaded in advance with data as to the width W and the transfer distance Ly of the paper 1 in the same manner. as the processor 5 which has been previously described.

The detecting apparatus B automatically detects the tilt angle θ of the paper as in the detecting apparatus A by operating the sensors 3, 4 and the processor 5B.

Unlike the previously-described detecting apparatus A, the detecting apparatus B does not need to feed the paper along the transfer path for detecting the tilt angle θ. Thus, even though the tilt angle θ changes at any time for some reason, it is possible to detect the tilt angle θ at any given time.

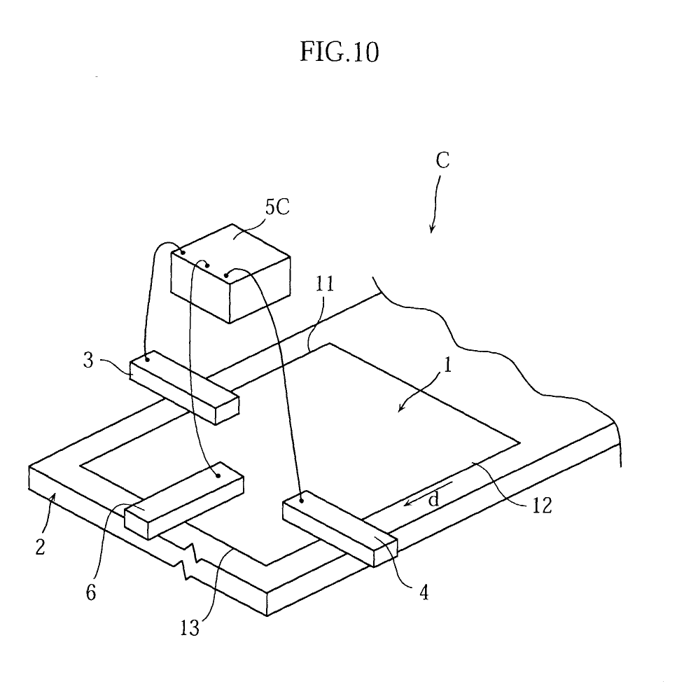

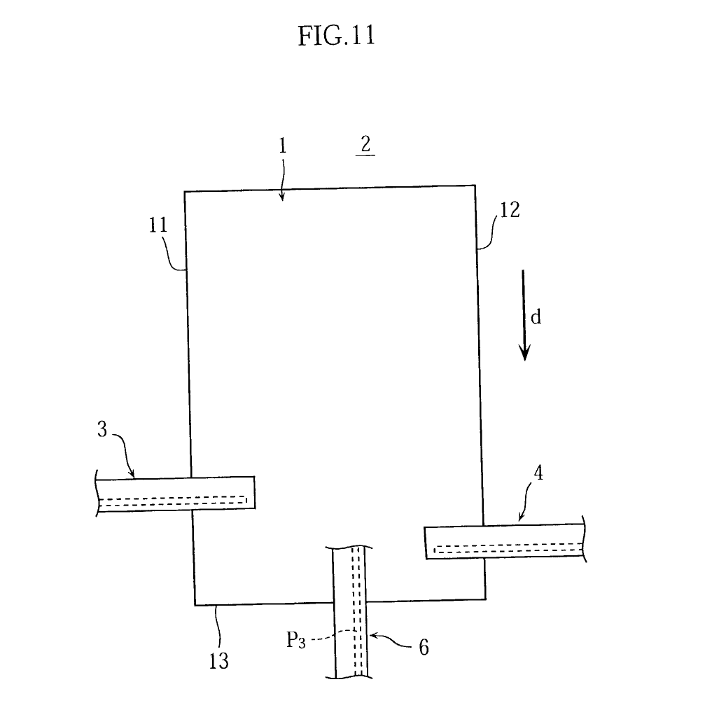

FIGS. 10 and 11 illustrate a paper detecting apparatus (generally represented by reference sign C) in accordance with a third embodiment of the present invention. The apparatus C differs from the previously-described apparatuses A, B in that it comprises a third linear sensor 6 in addition to the first and the second linear sensors 3, 4. These three sensors are connected to a data processor 5C. As in the apparatus B, the first and the second sensors 3, 4 are disposed offset from each other in the paper transfer direction d, as seen in FIG. 11. The third sensor 6 has a reading line P₃ in parallel to the direction d. The third sensor 6 is arranged so that the leading edge 13 of the paper 1 passes immediately under the reading line P₃.

The detecting apparatus C is capable of detecting the position of the leading edge of the transferred paper 1 at the third sensor 6. As a result, it is possible to determine the transfer distance (i.e. transfer speed) of the paper 1 per unit time. Such a third sensor may be incorporated into the apparatus A of the first embodiment in accordance with the present invention.

The preferred embodiments of the present invention being thus described, it is obvious that the same may be varied in various ways. Such variations should not be regarded as a departure from the spirit and scope of the invention, and all such variations as would be obvious to those skilled in the art are intended to be included within the scope of the claims given below.

1. A paper detecting apparatus comprising:
a transfer base for transferring a sheet of paper in a predetermined transfer direction, the paper including a first and a second side edges in parallel to each other;
a first linear sensor including a first linear reading region for detecting the first side edge;
a second linear sensor including a second linear reading region for detecting the second side edge; and
a data processor for processing data obtained by the first and the second sensors;
wherein the first and the second sensors are disposed in such a manner that the first and the second linear reading regions are positioned transversely to the transfer direction; and
wherein the data processor detects a tilt angle of the paper relative to the transfer direction based on positional information of the first and the second side edges obtained by the first and the second sensors.

2. The apparatus according to the claim 1, wherein the data processor detects the tilt angle based on first and second positional information, the first positional information being obtained when the paper assumes a first position, the second positional information being obtained when the paper assumes a second position different from the first position.

3. The apparatus according to the claim 1, wherein the first and the second sensors are located offset from each other in the transfer direction.

4. The apparatus according to the claim 1, wherein each of the first and the second sensors includes an illuminator for irradiating the paper with scattered light rays.

5. The apparatus according to the claim 4, wherein the illuminator includes light-emitting elements of red, green, and blue colors.

6. The apparatus according to the claim 1, wherein the transfer base includes a black surface for placing the paper.

7. The apparatus according to the claim 1, further comprising a third linear sensor including a third linear reading region for detecting an edge of the paper extending between the first and the second side edges, wherein the third linear reading region extends in parallel to the transfer direction.
